(19) United States
(12) Patent Application Publication
(10) Pub. No.: US 2013/0247444 A1
(43) Pub. Date: Sep. 26, 2013

(54) Collared Fishing Lure with Pivotable Hook

(71) Applicants: John YOUNG, Andover, KS (US); Shane PICKETT, Rose Hill, KS (US)

(72) Inventors: John YOUNG, Andover, KS (US); Shane PICKETT, Rose Hill, KS (US)

(21) Appl. No.: 13/847,874

(22) Filed: Mar. 20, 2013

Related U.S. Application Data
(60) Provisional application No. 61/613,596, filed on Mar. 21, 2012.

(51) Int. Cl. A01K 85/00

(52) U.S. Cl. CPC A01K 85/00
USPC 43/42.09; 43/42.39

(57) ABSTRACT

A collared fishing lure having a pivotable hook. The fishing lure can include a head, a stem extending from the head, the stem having a collar disposed at a distal end thereof, the diameter of the collar being greater than the diameter of the stem, a coupling, disposed at the distal end of the stem, for removably attaching a hook thereto, the coupling adapted to allow the hook to pivot with respect to the stem.

### CROSS-REFERENCE TO RELATED APPLICATIONS

This application claims priority to U.S. Provisional Application 61/613,596, filed Mar. 21, 2012 and entitled COLLARED FISHING LURE WITH PIVOTABLE HOOK, the entire contents of which are hereby incorporated by reference.

### BACKGROUND

Fishing lures and jigs are frequently used for attracting and catching fish. To that end, it is desirable that a fishing lure mimics the appearance and movement of the prey of a desired fish, so as to better attract the fish. It is also desirable that, once a fish is hooked, that the fish does not escape. A fishing lure that facilitates natural movement and facilitates securely hooking a fish is therefore desired.

### SUMMARY

According to at least one exemplary embodiment, a collared fishing lure with a pivotable hook may be disclosed. A collared fishing lure having a pivotable hook. The fishing lure can include a head, a stem extending from the head, the stem having a collar disposed at a distal end thereof, the diameter of the collar being greater than the diameter of the stem, a coupling, disposed at the distal end of the stem, for removably attaching a hook thereto, the coupling adapted to allow the hook to pivot with respect to the stem.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows a top view of an exemplary embodiment of a collared fishing lure with pivotable hook.

FIG. 2 shows a top view of an exemplary embodiment of a collared fishing lure with pivotable hook.

FIG. 3a shows a top view of an exemplary embodiment of a collared fishing lure with pivotable hook with a skirt attached.

FIG. 3b shows a detail cross-sectional view of the coupling between the lure and the skirt.

FIG. 4 shows a top view of an exemplary embodiment of a collared fishing lure with pivotable hook with a skirt and a lure member attached.

FIGS. 5a-5b are top views of further exemplary embodiments of a collared fishing lure with pivotable hook.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a collared fishing lure with pivotable hook 100 may be disclosed. Lure 100 may include a body 102 to which a hook 120 may be coupled. Body 102 can include a head 104 and a collar 106 positioned at a distal end of a stem 108. Hook 120 may be coupled to body 102 substantially at the distal end of stem 108. Hook 120 may be positioned concentrically with collar 106.

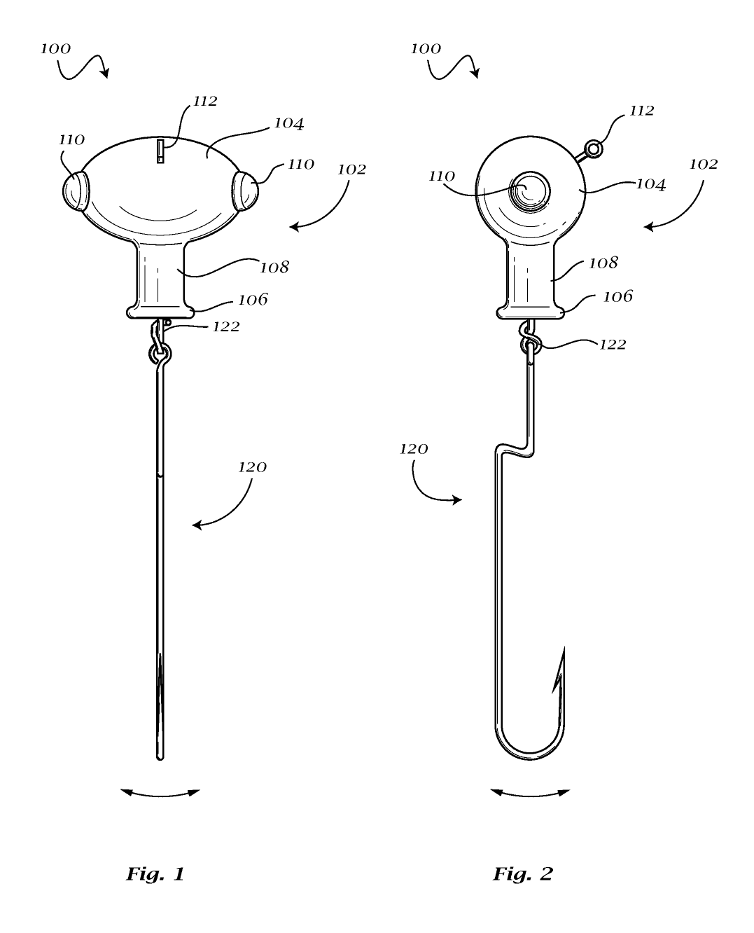

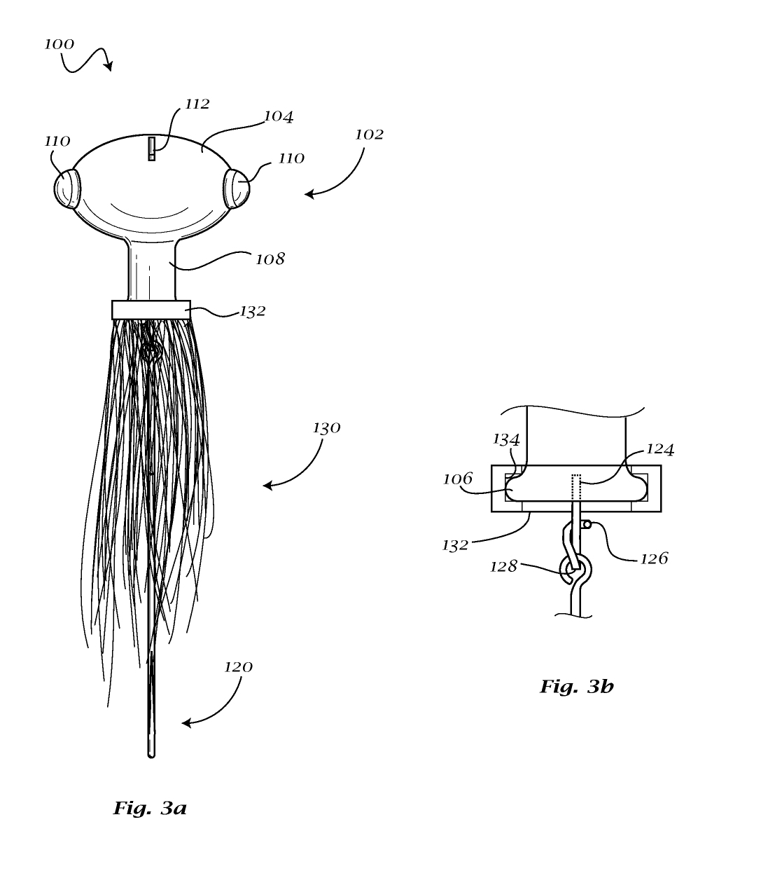

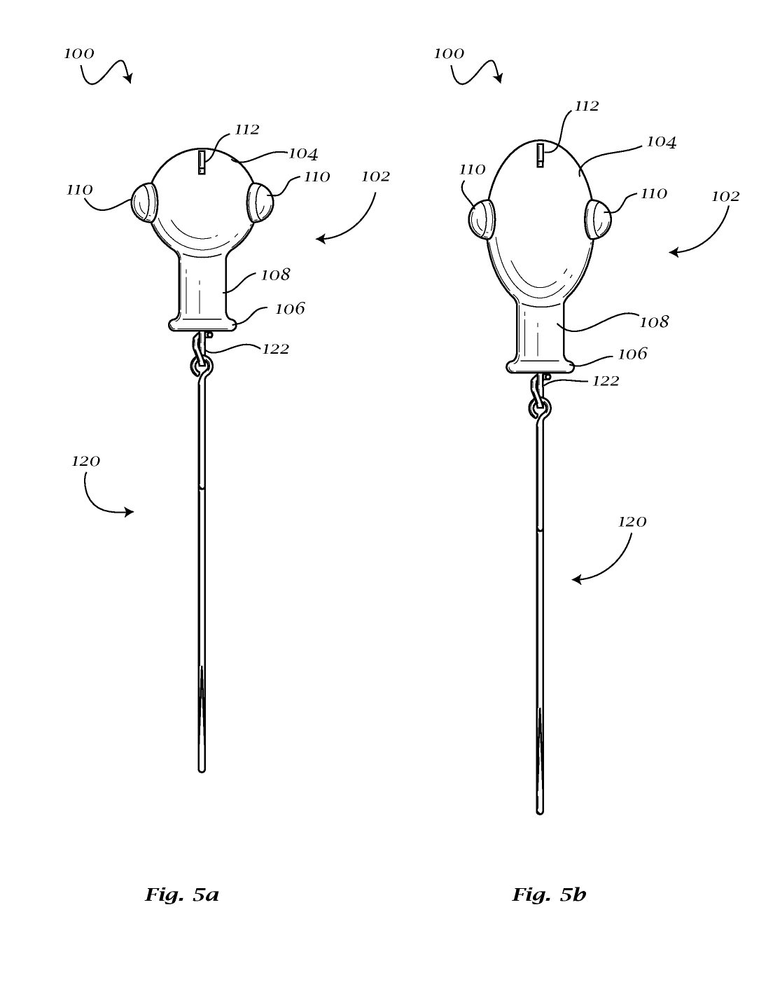

Head 104 may be formed as, or provided with a weight, for example, with a lead mass disposed within head 104, or any other weighed, dense material that enables lure 100 to function as described herein. In some embodiments, head 104 may be formed integrally with stem 108 and collar 106. In some embodiments, head 104 may be formed from lead in its entirety. In various exemplary embodiments, head 104 may have any desired shape, for example a spherical shape, a spheroid shape, or any other shape that enables lure 100 to function as described herein. Furthermore, in the exemplary embodiments where head 104 has a spheroid shape, the major axis of head 104 may be oriented parallel to the longitudinal axis of lure 100, or perpendicular to the longitudinal axis of lure 100. Embodiments illustrating exemplary shapes for head 104 are shown in FIGS. 1-2 and 5a-5b.

Head 104, and additionally stem 108 and collar 106 may further be covered with a coating, which may have any desired color or design, for example a color or design that facilitates attracting fish.

Head 104 may further include simulative indicia, which may be, for example, eyes 110. Eyes 110 may be disposed on opposing sides of head 104, and may be coupled thereto, or may be formed as part of head 104. Eyes 110 may be formed as substantially hemispherical protrusions extending from the surface of head 104. Eyes 110 may be contrasted from head 104, for example eyes 110 may have a different color than head 104. Additionally, eyes 110 may be reflective, transparent, or translucent.

Extending from head 104, and concentric with an axis of head 104, may be stem 108. Stem 108 may have any desired shape, for example a cylindrical shape. Positioned at the distal end of stem 108 may be collar 106, which may be substantially circular and may have a diameter greater than a diameter of stem 108. The diameter of collar 106 may be such that a skirt 130 can be coupled to collar 106, for example by a friction fit of a portion of skirt 130 over collar 106.

A line coupling 112 may be provided on head 104. Line coupling 112 may be, for example, an eyelet or any other coupling that can facilitate attaching lure 100 to a fishing line or the like. Line coupling 112 may be formed, for example, from stainless steel.

Disposed at the distal end of stem 108 may also be hook 120. Hook 120 may be pivotably coupled to stem 108 such that hook 120 is free to pivot in relation to body 102. The pivotable coupling 122 between hook 120 and body 102 can allow hook 120 to pivot in several degrees of freedom with respect to body 102.

The pivotable coupling 122 between hook 120 and body 102 may be any coupling that enables lure 100 to function as described herein. Furthermore, hook 120 may be removably coupled to pivotable coupling 122. For example, in some embodiments, the pivotable coupling 122 may be a length of metal having a first end 124 disposed within stem 108, a free end 126, and a loop 128 disposed between the two ends 124, 126. The free end 126 may be movable, so as to allow free end 126 to be inserted through the eyelet of a hook 120. The free end 126 may then be positioned to engage the length of metal so as to maintain hook 120 coupled to body 102. The pivotable coupling 122 may be formed, for example, from stainless steel. In other exemplary embodiments, any known coupling that allows hook 120 to be removably and pivotably coupled to body 102 may be used, for example a clip, an openable ring, a clevis, a resilient coupling such as a coil spring, or any other coupling that enables lure 100 to function as described herein.

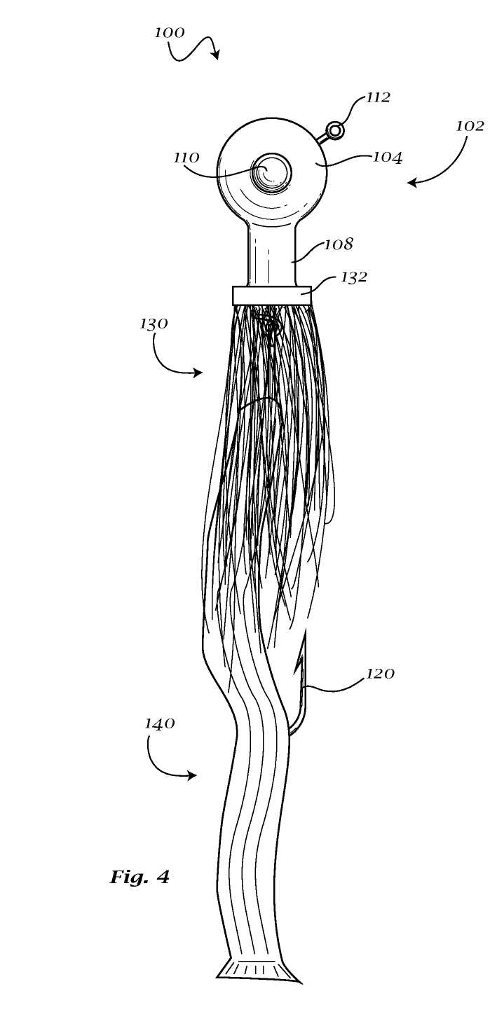

As shown in FIGS. 3a-3b, a skirt 130 may be removably coupled to collar 106 such that the coupling is sufficiently secure to maintain skirt 130 on collar 106 when lure 100 is in use. For example, skirt 130 may be provided with a resiliently flexible annular ring 132. The ring 132 may have a groove 134 defined in the inner surface thereof Groove 134 may have a width and depth sufficient to receive collar 106 therein. Skirt 130 can further include features for attracting fish, and can be any known lure skirt or other device that enables lure 100 to function as described herein. A variety of interchangeable skirts 130 may be provided for use with body 102.

As shown in FIG. 4, an additional lure member 140 may be coupled to hook 120 such that it is positioned over hook 120 when lure 100 is in use. Lure member 140 may be formed from plastic or any other desired material, and may have any desired color, or design, for example a color or design that facilitates attracting fish.

In operation, lure 100 may be attached to a fishing line or the like via line coupling 112. Lure 100 can then be placed in the water and pulled through the water as desired. The pivotable coupling 122 between body 102 and hook 120 can allow hook 120 and lure member 140 to mimic a natural movement as lure 100 is pulled through the water, thereby attracting fish to lure 100. Furthermore, once a fish has bit down on hook 120, pivotable coupling 122 can reduce the likelihood of the fish escaping, by allowing for freedom of movement between hook 120 and body 102. Thus, lure 100 can increase the likelihood of attracting a fish and of successfully reeling a hooked fish out of the water. Additionally, as the coupling 122 allows hook 120 to be removably coupled to body 102, the user may switch hooks as desired. For example, when hook 120 has become worn out from use, the user may replace the hook without having to dispose of body 102.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A fishing lure, comprising:
a head;
a stem extending from the head, the stem having a collar disposed at a distal end thereof, the diameter of the collar being greater than the diameter of the stem;
a coupling, disposed at the distal end of the stem, for removably attaching a hook thereto, the coupling adapted to allow the hook to pivot with respect to the stem.

2. The fishing lure of claim 1, further comprising a skirt removably coupled to the collar.

3. The fishing lure of claim 2, the skirt further comprising an annular ring having a groove defined in the inner surface thereof, the groove being sized to receive a portion of the collar therein.

4. The fishing lure of claim 1, the coupling further comprising a first end disposed within the stem, a second end disposed externally to the stem, and a loop disposed between the first end and the second end.

5. The fishing lure of claim 1, further comprising a pair of eyes disposed on opposing sides of the head and having a contrasting appearance to the head.

6. The fishing lure of claim 1, wherein the head has a spherical shape.

7. The fishing lure of claim 1, wherein the head has a spheroid shape.

8. The fishing lure of claim 7, wherein the major axis of the head is perpendicular to the longitudinal axis of the lure.

9. The fishing lure of claim 7, wherein the major axis of the head is parallel to the longitudinal axis of the lure.

10. A fishing lure, comprising:
a weighted head having a coupling for a fishing line disposed thereon;
a stem extending from the head, the stem having a collar disposed at a distal end thereof, the diameter of the collar being greater than the diameter of the stem; and
a hook pivotally and removably coupled to the distal end of the stem.

11. The fishing lure of claim 10, further comprising a skirt removably coupled to the collar.

12. The fishing lure of claim 11, the skirt further comprising an annular ring having a groove defined in the inner surface thereof, the groove being sized to receive a portion of the collar therein.

13. The fishing lure of claim 10, further comprising a pivotable coupling having a first end disposed within the stem, a second end disposed externally to the stem, and a loop disposed between the first end and the second end.

14. The fishing lure of claim 10, further comprising a pair of eyes disposed on opposing sides of the head and having a contrasting appearance to the head.

15. The fishing lure of claim 10, wherein the head has a spherical shape.

16. The fishing lure of claim 10, wherein the head has a spheroid shape.

17. The fishing lure of claim 16, wherein the major axis of the head is perpendicular to the longitudinal axis of the lure.

18. The fishing lure of claim 16, wherein the major axis of the head is parallel to the longitudinal axis of the lure.
